(19) United States
(12) Patent Application Publication
(10) Pub. No.: US 2005/0004975 A1
(43) Pub. Date: Jan. 6, 2005

(54) Adaptive connection for data transmission

(76) Inventor: Shashi Prasad, Princeton, NJ (US)

Correspondence Address: KAPLAN & GILMAN , L.L.P., 900 ROUTE 9 NORTH, WOODBRIDGE, NJ, 07095, US

(21) Appl. No.: 10/602,296

(22) Filed: Jun. 24, 2003

Related U.S. Application Data
(60) Provisional application No. 60/468,616, filed on May 5, 2003.
(60) Provisional application No. 60/453,935, filed on Mar. 12, 2003.

(51) Int. Cl. G06F 15/16

(52) U.S. Cl. 709/203

(57) ABSTRACT

An adaptive connection system for message transmission from a source application to a destination application, comprising a first gateway to interfacing the sending application with a first protocol, a second gateway to interfacing the receiving application with a second protocol, and a connection server bridging between the first and second gateways over a network for receiving the message from the first gateway and forwarding the same to the second gateway. The connection server further provides tracking information to the source and/destination to check the transmission status.

This application claims the benefit of and incorporates by reference the entirety of U.S. Provisional Patent Applications 60/468,616 filed May 5, 2003 entitled “ADAPTIVE CONNECTION FOR DATA TRANSMISSION” and 60/453,935 filed Mar. 12, 2003 entitled “INTERNET CONNECTION SYSTEM.”

### TECHNICAL FIELD OF INVENTION

The present invention relates to data transmission, in particular, to a novel connection solution adaptive to both a sending application and the receiving application without a need for changing the applications, even when the applications are not of the same protocol, of the same platform, or compatible to each other. Furthermore, the novel adaptive connection leverages internet protocols while still being able to perform secure and reliable data transmission.

### BACKGROUND OF THE INVENTION

Information transmission between an enterprise and its suppliers, customers and/or partners is a fundamental business process, which requires a secure and reliable connectivity. Information transmission over a data network, however, is still limited to only a small fraction of endpoints because of its high cost to implement even for a large enterprise. Enterprises need connectivity strong and robust enough to exchange mission critical business data, which requires enterprises to manage a complex, costly and time consuming deployment process. Often, solutions must be custom-built and are limited to specific internal applications. Protocol and platform incompatibilities between enterprises prevent applications from being connected, and for some enterprise solutions, every endpoint must utilize the same messaging infrastructure. Obviously, this is not applicable to a now widely diverse, heterogeneous environment in which the enterprises struggle.

The Internet offers a ubiquitous backbone with open, flexible protocols, which may substantially slash the cost of connectivity and extend an organization's connectivity reach. It, however, does not inherently provide the security and reliability that corporations need to exchange important business information, nor does it provide the asynchronous processing paradigms needed for effective application-to-application integration.

Thus, there exists a need for a technique to leverage internet protocols—both inside the enterprise and across firewalls—to their suppliers, partners, and customers. Moreover, for a reliable transmission of important enterprise data, the users involved are always interested in a capability to track the transmission status.

### SUMMARY OF THE INVENTION

To achieve the above objectives, a new connection system is provided for message transmission from a sending application at one computer to a receiving application at a second computer. In particular, the connection system comprises a first gateway to interface the sending application with a first protocol, a second gateway to interface the receiving application with a second protocol, and a connection server bridging between the first and second gateways over a network for receiving the message from the first gateway and forwarding the same to said second gateway. Thus, the sending application and the receiving application do not need to match in protocol to communicate. In a preferred embodiment, the first and/or second protocol uses one of several standard Internet protocols.

The connection system may generate tracking information for each message transmission, which includes at least the tracking number and the transmission status. The tracking number is provided to the first and/or second computers, and the tracking record may be kept in the connection server or a separate tracking information server, which is preferably accessible by the users over the Internet.

Each of the gateways may keep a plurality of interfaces, each suitable for a specific protocols. The gateways preferably include ports for various protocols such as HTTP, SMTP, FTP, or others. These ports are termed listeners, each gateway having plural listeners so that it may interface with each protocol. Each gateway communicates with the associated application using the protocol implemented by that application. Thus, the first gateway may communicate over a specified port with an application using HTTP, and the second gateway may communicate with its associated application using a different port number and a different protocol. Each gateway has plural ports with which to listen, and preferably each port will convey data using a predetermined protocol associated with that port.

Morphing modules may be provided in the gateways to examine and modify the message if necessarily. In particular, a morphing module is provided at the second gateway to change the data to a format suitable to the receiving application. The morphing module may perform further functionality. For example, morphing may validate certain messages, and declare others to be unauthorized by conveyance to the receiving application. The morphing module may require authorization to convey messages, may discard certain messages in part or in their entirety, or may perform any other filtering functions with respect to the communications being conveyed. The morphing module operates as a configurable filter, which may be configured based upon user preferences, the expected traffic types and flow, or other suitable parameters.

The message or data transmitted is encrypted at the first gateway, enclosed in an “envelope” for transmission, and is decrypted at the second gateway.

### BRIEF EXPLANATION OF THE DRAWINGS

The above and other features and advantages will be clearer after reading the following detailed description of the preferred embodiment of the invention, with reference to the accompanying drawings, in which:

FIG. 1 illustrates a basic adaptive connection topology of the present invention;

FIG. 2 illustrates in more detail the elements in the inventive adaptive connection system;

FIG. 3 is a flow chart showing the message transmission stages in the system of FIG. 2; and

FIG. 4 illustrates a tracking server incorporated in the connection system.

### DETAILED DESCRIPTION OF THE PREFERRED EMBODIMENTS

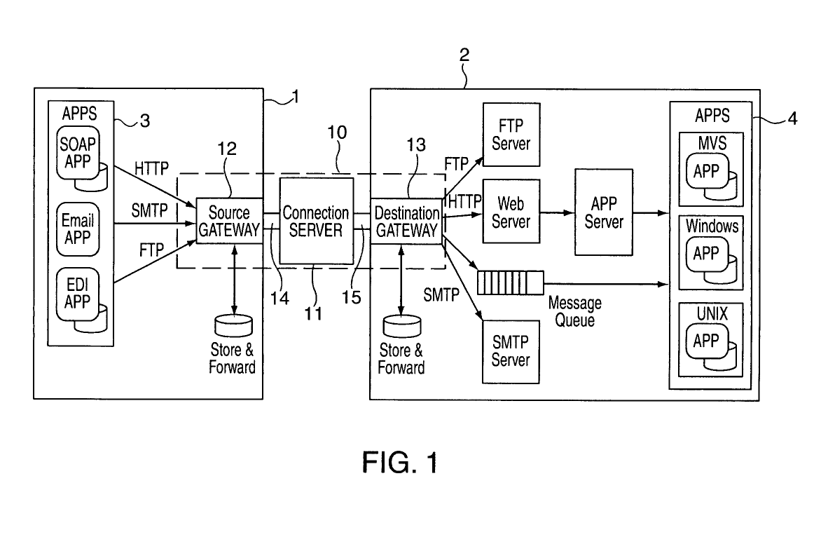

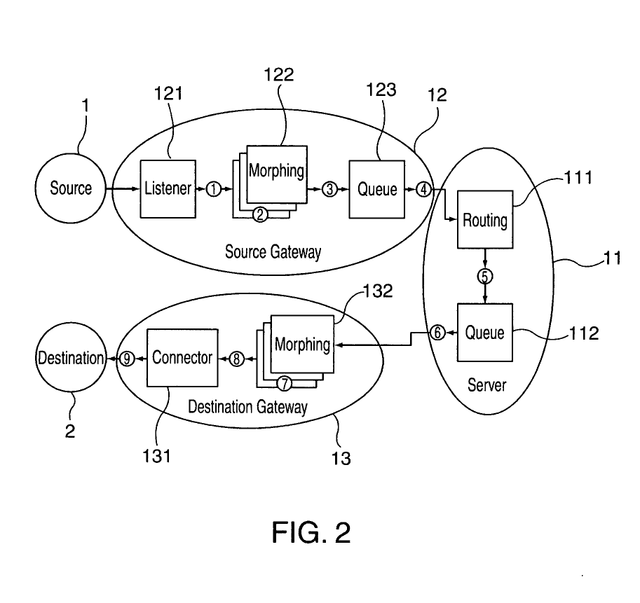

FIG. 1 shows a basic topology of the data/message transmission from a source 1 to a destination 2, in which the adaptive connection system 10 of the present invention is incorporated. The inventive adaptive connection system 10 basically comprises a connection server 11, a source gateway 12 and a destination gateway 13. As shown in FIG. 1, the source gateway 12 is capable of interfacing any one of the applications 3 with corresponding one of several internet protocols, e.g., SMTP, FTP or HTTP. For example, if data is sent from an EDI application using FTP protocol, the source gateway 12, will receive such data on the port associated with FTP. As shown in FIG. 2 with more detail, this is done by employing plural listeners 121, provided in the source gateway 12. Thus, the source gateway 12 is capable of communicating with any of the applications 3, no matter what internet protocol is used by the sending application, because the gateway 12 includes various listeners that each operate on different ports.

A major consequence of the adaptive protocol handler, or the listener 121, is that applications 3 do not need to contain logic that invokes the API of message queuing systems with which they may communicate. This greatly expands the number of applications that can participate in a business connectivity solution. Another benefit of the adaptive protocol handler 121 is that it makes business connectivity non-intrusive since applications 3 do not need to be changed, regardless of the communications protocol being utilized, and regardless of the application running a computer with which the application is communicating.

With the appropriate listener, the source gateway 12 receives the data from sending application 3, which includes the address information of the desired destination 2. The protocol to be utilized by the desired destination is determined by the connection server. This determination allows the destination gateway 13 to determine which protocol and which port to use in communicating with the receiving application. The data is then sent to the connection server 11 through a data network 14. The connection server 11 also extracts the destination address information to route the data to the destination gateway 13, through a data network 15.

Upon receipt of the data from the connection server 11, the destination gateway 13, is caused to utilize the protocol that matches the protocol used by the destination application 4, as indicated by the connection server 11. This is done by a connector 131 provided in the destination gateway 13. Thus, the data is successfully sent from the destination gateway 13 to a receiving application 4 at the desired destination 2, which may be using a different protocol from the one used by the sending application, or even running on a different platform. For instance, data can be sent via HTTP and placed on an MQ series queue at the receiving end. Applications using NET's underlying queuing technology, MSMQ, can exchange data with applications using a different (or no) queuing system. No commitment to a major new infrastructure is required.

With the connection server 11 standing between the source 1 and the destination 2, asynchronous data transmission can be realized even when both sending and receiving applications 3 and 4 are synchronous ones.

A fundamental business connectivity requirement is the ability to transform, or morph, business data from the sender's application format into the format of the receiver's application. Recipient companies may use differing applications, so the technology must allow data to morph differently depending on the specific destination application's needs. To this end, one or more morphing modules 122 and 132 are provided in the source gateway 12 and the destination gateway 13 to examine and modify the data. In particular, the morphine 132 in the destination gateway 13 may alter the received data to a format that is suitable to the receiving application 4.

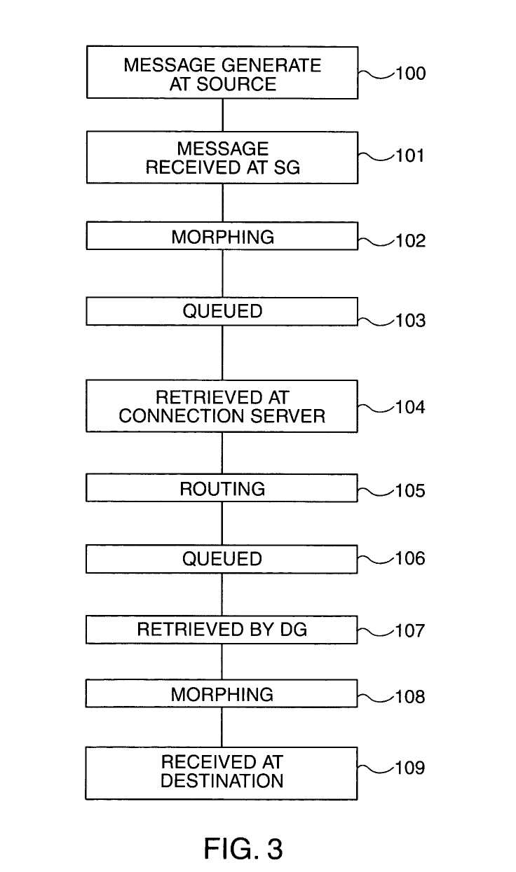

FIG. 3 shows a flow chart depicting the data transmission sent from the source 1, through the connection system 10 reaching the desired destination 11, as illustrated in FIGS. 1 and 2. The data is generated by an application 3 (e.g., HTTP application, message queue, etc.) at the source 1, at step 100. With the proper protocol the data is received by the source gateway 12, at step 101. At the source gateway 12, the data is undergoing morphing (possibly by multiple morphing modules) at step 102, then is queued onto a message queue 123 to go to the connection server 11, at step 103. The data is retrieved by the connection server 11, at step 104, and goes through the routing process by a routing module, at step 105, and then is queued onto a message queue 112 to go to the destination gateway 13, at step 106. The data is retrieved by the destination gateway 13 at step 107. Again, the data undergoes morphing at step 108, possibly tailored to the format required by the receiving application 4. Finally the data is sent to its final destination at step 109, and a response is generated to indicate the successful transmission.

For the security of data transmission, the data is encrypted at the source gateway 12, and is decrypted at the destination gateway 13. Furthermore, it is important to provide traceable and auditable information to the users regarding their data transmissions.

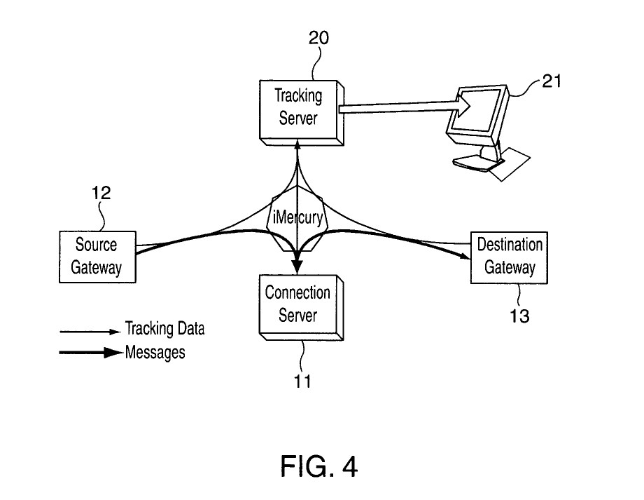

As shown in FIG. 4, a tracking server 20 is provided to keep and maintain a tracking record for each data transmission. Typically, a tracking number is generated for a specific data transmission at the source gateway 12 upon receipt of the data from the sending application. The status of the data transmission at some steps from 101 to 109 are reported from the related servers and/or gateways directly to the tracking server 20, or forwarded by the connection server 11 to the tracking server 20. The tracking server 20 can be the same one as the connection server 11, or a separate one remotely located from the connection server 11.

Preferably, the tracking server 20 is accessible by the user over the Internet, e.g., through a browser in a display 21, with the tracking number that he has received from the source gateway or connection server 11 or the tracking server 20. This will permit a user to ascertain the status of the data transmission. Additionally, tracking numbers may be assigned by any other source connected to the network. Messages may also be tracked using any other parameter of the message, rather than a tracking number.

Preferably, auditing information is provided by the source gateway 1, or by the destination gateway 2, or by both. Auditing information can be added to the message being conveyed, or can be provided to the connection server 11 or to the tracking server 20 so as to be added to the tracking information.

The connection server 11 can be remotely located from both gateways 12 and 13, and the data link 14 and 15 can be the Internet, a LAN, or a WAN. Firewalls may be put between the gateways 12, 13 and the connection server 11. It is also possible to locate the connection server 1I at the same node with one of the gateways 12, 13.

We will now describe in further detail the convenience and acknowledgement of a message from one of applications 3 to applications 4. In operation, a message that is to be acknowledged would traverse the system of FIG. 3 from left to right. The message leaves one of applications 3 and arrives at gateway 12 via the appropriate one of the plural listeners installed at gateway 12. The gateway 12 would include listeners for most or all standardized Internet protocols (HTTP, FTP, SMTP) as well as listeners for operating from known queuing systems (e.g. MSMQ, Websphere, etc.) and file systems.

Messages may optionally then be processed by a filtering and morphing module. As described above, this step may result in some messages being altered, discarded, partially transmitted, etc. The parameters of the filtering and morphing are user configurable and highly flexible.

After optional filtering and morphing, the message is placed into a queuing system that I responsible for reliable delivery of the message once and only once. In the event of network outages, the system will continue to retry transmission as necessary in order to achieve delivery of the message once and only once.

At the connection server 11, the URI of the message is parsed and utilized to forward the message to its destination. The destination information associated with a message comprises preferably both the type of destination (e.g. web server, FTP server, SMTP server, etc) as well as the location of that destination. The destination information may contain the location of a gateway connected to the destination in addition to, or instead of, the destination information itself.

After the destination information is added, the message is then queued again at the server 11, and forwarded in a reliable and secure manner to destination gateway 13. tracking information may be generated and/or maintained at any of the gateways 12 and 13 or connection server 11. In addition, any of the aforementioned may communicate with one or more other computers to generate and store the tracking, audit, or other parameters related to the transmission of the message.

Upon arrival at destination gateway 13, the message may again be put through morphing and filtering modules, which can alter, reject, or allow the message. The implementation of morphing and filtering at gateway 13 need not operate based upon the same parameters as that in gateway 12. Thus, although gateway 12 may determine that a particular type of message is suitable to transmit to a particular application 4, and thus permit passage of that message, the destination gateway 13 may nonetheless reject that message.

After arriving at the destination gateway 13, the message is passed to the appropriate port (i.e.; listener) to transmit the message to the destination application. That listener could be, for example, FTP, SMTP, or HTTP. Upon receipt, the response message may be conveyed in the opposite direction back to the application 3, or a response may also be sent to a third destination that stores such response.

Though the preferred embodiments of the present invention have been described in detail as above, it shall be appreciated that numerous adaptations, variations and changes are possible to a skilled person in the art without departing from the spirit of the invention. Therefore, the scope of the invention is intent to be solely defined in the accompanying claims.

1. A method of transmitting data over a public packet switched network, the method comprising the steps of:
utilizing a transport protocol at each of two computers to facilitate the connection between the two computers;
interposing at least a first proxy between said two computers, said first proxy utilizing the transport protocol, the proxy server providing auditing and acknowledgment functionality, in addition to functionality provided by the two computers.

2. The method of claim 1 further comprising interposing two proxy servers between said two computers.

3. The method of claim 1 wherein a first of said two computers is a client computer and a second of said computers is a server computer.

4. The method of claim 3 wherein a first proxy server emulates said server computer and is in communication with said client computer.

5. The method of claim 4 wherein said second proxy server emulates a client computer and is in communication with said server computer.

6. The method of claim 5 wherein at least one of said proxy servers assigns a tracking identifier to each unit of data transmitted through said at least one proxy server.

7. The method of claim 6 wherein said tracking number is conveyed with said unit of data from said first proxy to said second proxy, and wherein said tracking identifier is also conveyed to said client computer.

8. The method of claim 7 wherein plural said tracking numbers are stored in said client computer, thereby providing a history of the conveyance of each of said data units.

9. The method of claim 8 wherein delivery information for each unit of said data is stored on said first proxy or on an audit server, and wherein said client computer establishes communication with said first proxy or said audit server, and wherein said delivery information is viewable at said client computer to thereby provide tracking information for each of said units of data.

10. The method of claim 9 wherein the data units are packets.

11. A method of tracking communications sent from a first computer to a second computer over a data network, the method comprising:
transmitting data from a client computer to a proxy that emulates a server computer with which said client computer is arranged to communicate;
assigning audit information to said data, and transmitting said audit information both towards the server computer and in the opposite direction towards the client computer.

12. The method of claim 11 wherein said transmission of said audit information towards the client computer and towards said server computer occurs substantially simultaneously.

13. The method of claim 11 wherein said audit information is stored in a manner such that it is remotely accessible over a packet switched data network.

14. The method of claim 13 wherein transmitting said audit information toward said server includes transmitting said audit information to a second proxy.

15. The method of claim 14 wherein said second proxy communicates with said server, and wherein said second proxy also maintains audit information concerning data transmitted and received.

16. A method of conducting a communication session using a file transfer protocol comprising: initiating a communications session between a client and a server through at least two proxies, said communications session being configured at the client and server to encapsulate plural separate files;
receiving, a first proxy associated with said client, files encapsulated within a single communications session;
encapsulating said files into separate communications sessions at said first proxy;
transmitting said separately encapsulated files over a packet switched data network from a first proxy to a second proxy.

17. The method of claim 16 wherein audit information concerning each separately encapsulated file is generated by either said first or second proxy.

18. The method of claim 17 wherein, in the event of a failure of a server during transfer of said files, a new session is automatically initiated by one of said the first proxy or the second proxy.

19. A proxy server for communication with a computer protected by a firewall, said proxy server comprising a processor for detecting a transport protocol used to communicate through the firewall over a data network, and means for automatically configuring the proxy server to utilize said transport protocol.

20. The proxy server of claim 19 further comprising a processor programmed to generate audit data and to transmit said audit data to a computer from which information to be transmitted is received and to a second proxy server.

21. A proxy server to be interposed between two computers configured to communicate over a data network, said proxy server comprising software for auditing and tracking data units conveyed from a client computer to said proxy server and to be conveyed over a data network to a server computer, said proxy server being configured to examine each data unit conveyed through said proxy server, and to send a tracking code in two directions, one being toward the client and another direction being toward the server computer.

22. Apparatus comprising at least two proxy servers interconnected over a data network, the network including nodes that communicate via various transport layer protocols, the apparatus comprising a first proxy server configured to emulate a client computer, a second proxy server configured to emulate a server computer with which the client computer is intended to communicate, each of said first and second proxy server being configured to communicate using a selected one of said transport layer protocols, and having software to convert any data received from either said client computer or said server computer to utilize said selected transport layer protocol for communications between said first and second proxy server.

23. Apparatus of claim 22 wherein said first and second proxy servers communicate using HTTP.

24. Apparatus of claim 23 wherein at least one of said proxy servers is configured to communicate with a message queuing system associated with a software application.

25. Apparatus of claim 24 wherein at least one of said proxy servers communicates with a computer using HTTP, FTP, or SMTP.

26. A method for transmitting data from a first computer to a second computer, comprising:
sending, by means of a sending application using a first protocol at said first computer, said data to a connection system;
receiving said data at said connection system; and
sending, using a second protocol, said received data from said connection server to a receiving application at said second computer.

27. The method of claim 26, further comprising a step of determining, at said connection system, said first protocol and selecting the same one from plurality protocols to interface said first protocol.

28. The method of claim 26, wherein said data received at said connection from said first computer comprises address information of said second computer.

29. The method of claim 26, further comprising a step that said first computer informs said connection system of said second protocol to be used by said second computer.

30. The method of claim 29, further comprising a step, at said connection system, selecting, upon being informed of said second protocol, the same one from plurality protocols to interface said second protocol.

31. The method of claim 26, wherein said connection system comprises a connection server, a first gateway for receiving said data from said first computer and a second gateway for sending said received data to said second computer.

32. The method of claim 30, further comprising encrypting said data in an envelop at said first gateway.

33. The method of claim 30, further comprising decrypting said enveloped data at said second gateway.

34. The method of claim 30, further comprising morphing said data at said first gateway and/or said second gateway.

35. The method of claim 30, further comprising morphing said data at said second gateway to change said data to a format suitable to the receiving application at said second computer.

36. The method of claim 26, further comprising generating and maintaining, at said connection system, a tracking record including a tracking number and status for said data transmission.

37. The method of claim 35, further comprising sending, from said connection system, said tracking number back to said first computer and/or said second computer.

38. The method of claim 26, comprising sending said data from said first computer to said connection system synchronously, and sending said received data from said connection system to said second computer asynchronously, or vise versa.

39. The method of claim 26, wherein said first protocol one of Internet protocols.

40. The method of claim 26, wherein said second protocol one of Internet protocols.

41. An adaptive connection system for message transmission from a sending application at a first computer to a receiving application at a second computer, comprising:
a first gateway to interfacing said sending application with a first protocol; a second gateway to interfacing said receiving application with a second protocol; and
a connection server bridging between said first and second gateways over a network for receiving said message from said first gateway and forwarding the same to said second gateway.

42. The adaptive connection system of claim 41, wherein each of said gateways comprises multiple interfaces each suitable to one of multiple protocols.

43. The adaptive connection system of claim 42, wherein said first gateway comprises a protocol handler to identify the first protocol used by said first computer and to select the same one from the multiple protocols to interface said sending application.

44. The adaptive connection system of claim 42, wherein said second gateway comprises a protocol handler to select said second protocol from said multiple protocols to face said receiving application.

45. The adaptive connection system of claim 41, wherein each of said gateways comprises a morphing module to examine and change said data received by respective gateway.

46. The adaptive connection system of claim 45, wherein said morphing module at said gateway is capable of changing said data to a format suitable to said receiving application.

47. The adaptive connection system of claim 41, wherein said first protocol is one of internet protocols.

48. The adaptive connection system of claim 41, wherein said second protocol is one of internet protocols.

49. The adaptive connection system of claim 41, wherein said connection server comprises means for generating tracking information for said message including a tracking number and transmission status.

50. The adaptive connection system of claim 49, wherein said connection server comprises means for providing said tracking number to said first computer and/or said second computer.

51. The adaptive connection system of claim 49, further comprises a tracking server for keeping and maintaining said tracking data.

52. The adaptive connection system of claim 51, wherein said tracking server is the same as said connection server.

53. The adaptive connection system of claim 51, wherein said tracking server is remotely located from said connection server, and is accessible by said first and/or second computer over internet.

54. The adaptive connection system of claim 41, wherein each of said first and second protocols is one of HTTP, FTP, SMTP.

55. The adaptive connection system of claim 41, wherein said connection server communicates with at least one of said two gateways through a firewall.

56. The adaptive connection system of claim 41, wherein said first gateway comprises means for encrypting said message in an envelop, and said second gateway comprises means for decrypting said enveloped message.

57. The adaptive connection system of claim 41, wherein each of said sending application and said receiving application can be either a synchronous application or an asynchronous application.
